(19) United States
(12) Patent Application Publication
(10) Pub. No.: US 2006/0132834 A1
(43) Pub. Date: Jun. 22, 2006

(54) Printer and network print system

(75) Inventor: Kazuhiro Kamimura, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Chiyoda-ku (JP)

(21) Appl. No.: 11/015,987

(22) Filed: Dec. 16, 2004

(51) Int. Cl. G06F 3/12

(52) U.S. Cl. 358/1.15

(57) ABSTRACT

A printer according to an aspect of this invention comprises a sending unit which sends, in accordance with a test print instruction of a predetermined document from the terminal device, one or a plurality of print parameters, of a predetermined number of print parameters of the predetermined document, to a terminal device, a receiving unit which receives the print parameter or the plurality of print parameters sent back from the terminal device, a print instruction unit which instructs print of the predetermined document in accordance with the predetermined number of print parameters on which the print parameter or the plurality of print parameters sent back from the terminal device are reflected, and a printing unit which prints the predetermined document in accordance with the predetermined number of print parameters on which the print parameter or the plurality of print parameters are reflected.

### BACKGROUND OF THE INVENTION

1. Field of the Invention

This invention relates to a printer connectable with a terminal device via a network and a network print system in which the printer and the terminal device are connected via the network.

2. Description of the Related Art

Recently, a multi-functional printer (MFP) having a plurality of functions such as scanning, copying, printing and the like has appeared. The MFP can, for example, convert an office document into electronic form, and manage and utilize the electronic document. A paperless office can be thereby implemented. For example, the MFP can save document data taken by scanning or transmitted from a terminal via a network. The terminal connected to the MFP can instruct the MFP to print the document saved in the MFP.

However, there is a problem that before printing a document in the MFP, the user cannot easily confirm the contents of the documents by the terminal connected to the MFP via the network. For example, the user can easily confirm the document stored in a HDD or the like inside a personal computer (PC), on a display of the PC. This is because the PC can read and display the data of the document stored in the HDD or the like at a high speed. If the user attempts to confirm the contents of the document in the MFP by the terminal connected to the MFP via the network, the user needs to receive the document data by the terminal via the network. In other words, a receive standby time of the document data is generated and a problem about communications load over the network thereby arises.

### BRIEF SUMMARY OF THE INVENTION

The object of the present invention is to provide a printer and a network print system capable of making contents of a document easily understood.

According to an aspect of the present invention, there is provided a printer connectable with a terminal device via a network. The printer comprises a sending unit which sends, in accordance with a test print instruction of a predetermined document from the terminal device, one or a plurality of print parameters, of a predetermined number of print parameters of the predetermined document, to the terminal device, a receiving unit which receives the print parameter or the plurality of print parameters sent back from the terminal device, a print instruction unit which instructs print of the predetermined document in accordance with the predetermined number of print parameters on which the print parameter or the plurality of print parameters sent back from the terminal device are reflected, and a printing unit which prints the predetermined document in accordance with the predetermined number of print parameters on which the print parameter or the plurality of print parameters are reflected.

According to an aspect of the present invention, there is also provided a network print system in which a printer and a terminal device are connected via a network. The printer comprises a first sending unit which sends, in accordance with a test print instruction of a predetermined document from the terminal device, one or a plurality of print parameters, of a predetermined number of print parameters of the predetermined document, to the terminal device, a first receiving unit which receives the print parameter or the plurality of print parameters sent back from the terminal device, a print instruction unit a print instruction unit which instructs print of the predetermined document in accordance with the predetermined number of print parameters on which the print parameter or the plurality of print parameters sent back from the terminal device are reflected, and a printing unit which prints the predetermined document in accordance with the predetermined number of print parameters on which the print parameter or the plurality of print parameters are reflected. The terminal device comprises a second sending unit which sends the test print instruction of the predetermined document to the printer and which, in response to receiving of the print parameter or the plurality of print parameters from the printer, sends back the print parameter or the plurality of print parameters to the printer, and a second receiving unit which receives the print parameter or the plurality of print parameters from the printer.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing an example of a network print system;

FIG. 2 is a flowchart showing an example of a general print;

FIG. 3 is a flowchart showing an example of a test print;

FIG. 4 is an illustration showing an example of a document selection screen;

FIG. 5 is an illustration showing an example of selecting a predetermined document (thumbnail) on the document selection screen;

FIG. 6 is an illustration showing an example of displaying a pull-down menu from a file menu on the document selection screen;

FIG. 7 is an illustration showing an example of a general print setting screen;

FIG. 8 is an illustration showing an example of a test print setting screen;

FIG. 9 is an illustration showing an example of document properties; and

FIG. 10 is an illustration showing an example of a predetermined number of document properties.

### DETAILED DESCRIPTION OF THE INVENTION

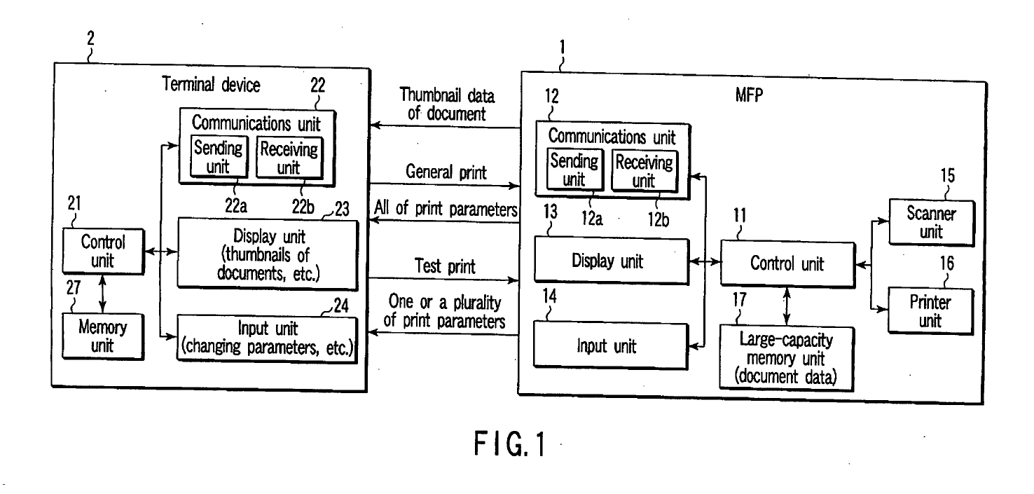

FIG. 1 is a block diagram showing an example of a network print system. For example, the network print system comprises a multifunctional printer (MFP) 1 and a terminal device 2, which are connected to each other via a network. In the network print system of FIG. 1, a single MFP 1 and a single terminal device 2 are connected. However, a plurality of MFPs 1 and the single administrative terminal device 2 may be connected via the network or the single MFP 1 and a plurality of administrative terminal devices 2 may be connected via the network. Moreover, a plurality of MFPs 1 and a plurality of administrative terminal devices 2 may be connected via the network.

For example, the MFP 1 comprises a control unit 11, a communications unit 12, a display unit 13, an input unit 14, a scanner unit 15, a printer unit 16 and a large-capacity memory unit 17. The large-capacity memory unit 17 may be an option, i.e. the MFP 1 may comprise the large-capacity memory unit 17 as an external unit. The terminal device 2 is, for example, a personal computer (PC), comprising a control unit 21, a communications unit 22, a display unit 23, an input unit 24 and a memory unit 27. The communications unit 12 of the MFP 1 includes a sending unit 12a and a receiving unit 12b. The communications unit 22 of the terminal device 2 includes a sending unit 22a and a receiving unit 22b. The communications unit 12 of the MFP 1 and the communications unit 22 of the terminal device 2 are connected via the network. Sending and receiving various kinds of data can be thereby executed between the MFP 1 and the terminal device 2.

The scanner unit 15 of the MFP 1 optically scans a document, and sends data of the scanned document to the large-capacity memory unit 17. The printer unit 16 reads and prints the document data stored in the large-capacity memory unit 17. The large-capacity memory unit 17 stores the document data sent from the scanner unit 15 or document data sent from the terminal device 2 connected via the network. The display unit 13 displays necessary information (various parameters and instructions) about the scanning function of the scanner unit 15, the printing function of the printer unit 16 and the copying function of the scanner unit 15 and the printer unit 16. The input unit 14 inputs the necessary information (various parameters and instructions) about the scanning function of the scanner unit 15, the printing function of the printer unit 16 and the copying function of the scanner unit 15 and the printer unit 16. The control unit 11 controls the operations of the scanning function, the printing function and the copying function on the basis of the information input from the input unit 14. The display unit 13 and the input unit 14 may be combined as a touch panel.

The memory unit 27 of the terminal device 2 stores, for example, a browser. The display unit 23 displays a screen generated on the basis of the browser. The input unit 24 is, for example, a keyboard, which inputs necessary information (test print instruction, general print instruction, etc. to be described later) to the browser screen. On the basis of the various kinds of information to be input to the browser, the control unit 21 outputs the test print instruction or the general print instruction to the MFP 1 to urge the MFP 1 to execute the test print or the general print.

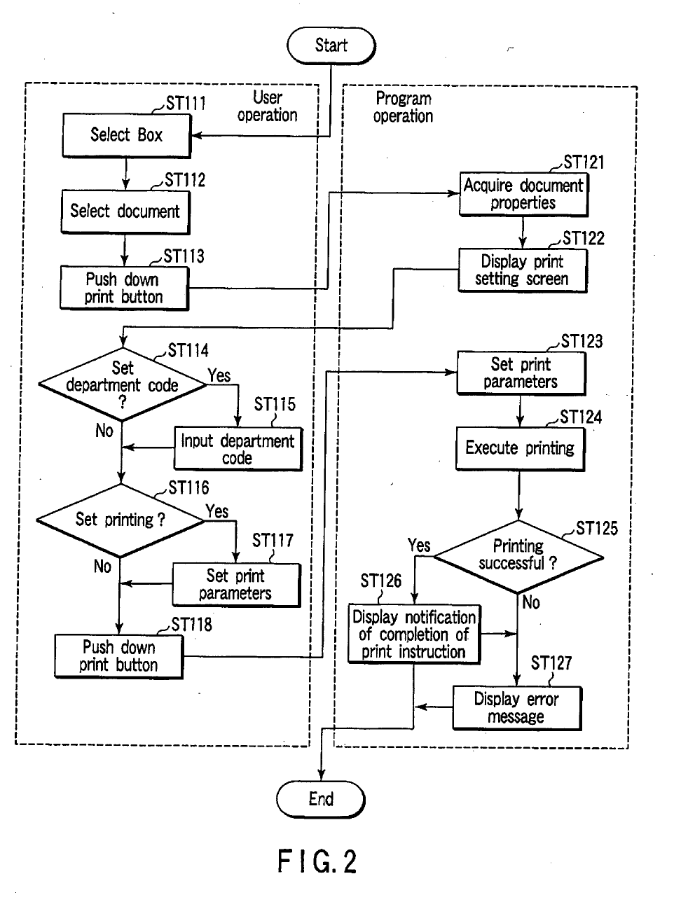

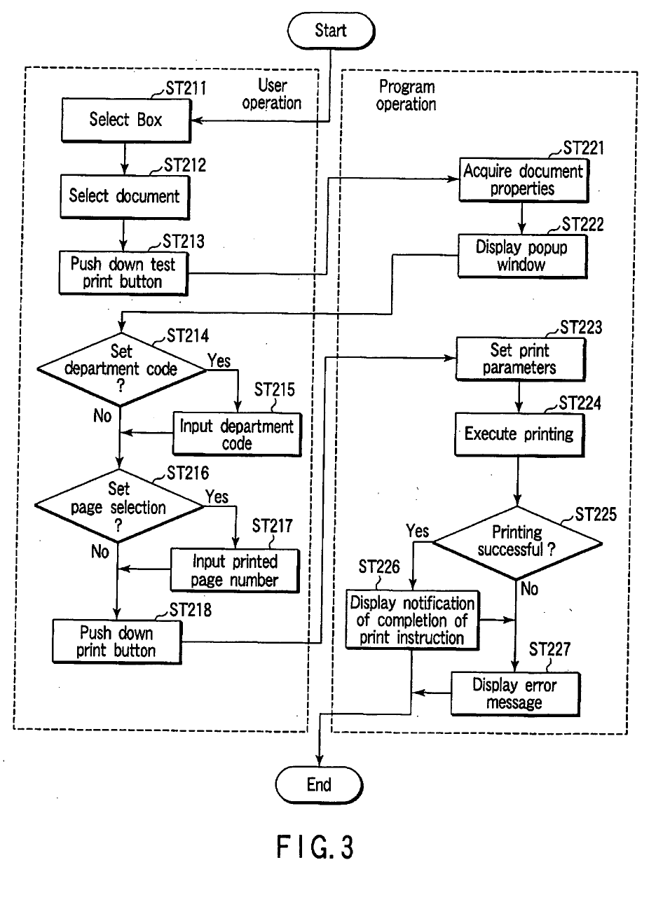

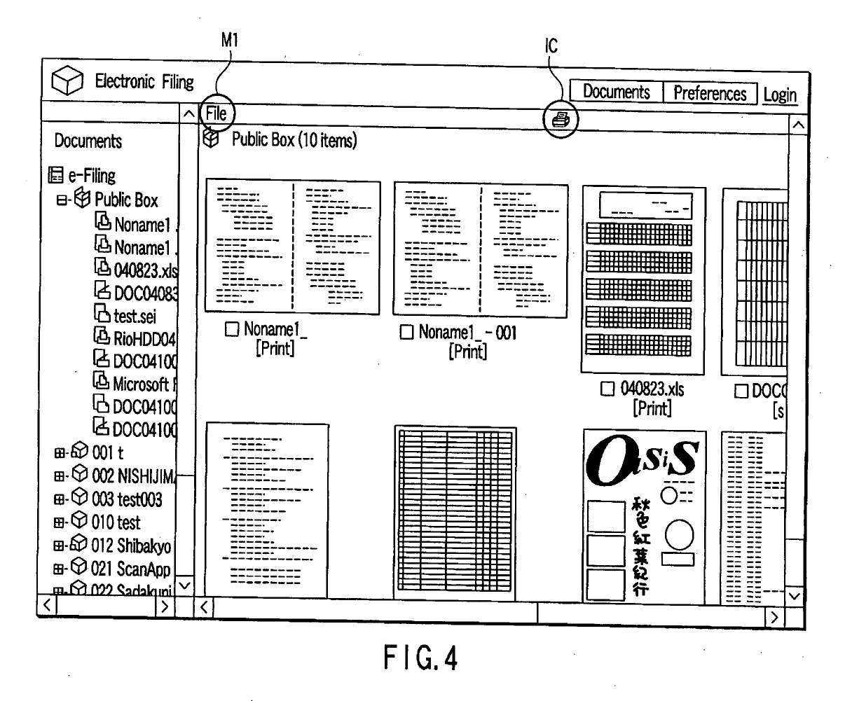

Next, the general print and the test print will be explained with reference to FIG. 2 to FIG. 8. FIG. 2 is a flowchart showing an example of the general print. FIG. 3 is a flowchart showing an example of the test print. FIG. 4 to FIG. 8 show browser display screens.

When the browser is started up in the terminal device 1, data of a plurality of documents stored in the large-capacity memory unit 17 of the MFP 1 can be browsed, via the network, on the browser display screen (display unit 23). However, if the data of a plurality of documents stored in the large-capacity memory unit 17 is to be sent to the terminal device 1 as it is, the receive standby time of the document data is generated on the terminal device 2 side and a problem about communications load over the network thereby arises as explained above.

To solve this problem, the MFP 1 (communications unit 12) does not send the data of one or a plurality of documents as it is, but sends thumbnail data of one or a plurality of documents, to the terminal device 2. The thumbnail data size of the documents is smaller than the data size of the documents. The communications time can be shortened and the communications load can be reduced.

The general print will be explained with reference to the flowchart of FIG. 2 and the browser display screen of FIG. 4 to FIG. 7, in view of sending such thumbnail data.

The user selects a predetermined box (folder) in the large-capacity memory unit 17 of the MFP 1, on an initial screen of the browser of the terminal device 2 (ST111). In accordance with the box selection, the MFP 1 (communications unit 12) sends the thumbnail data of one or a plurality of documents inside the selected box. In response to this, the document selection screen as shown in FIG. 4 is displayed on the display unit 23 of the terminal device 2. A list of the thumbnails of the respective documents is displayed on the document selection screen.

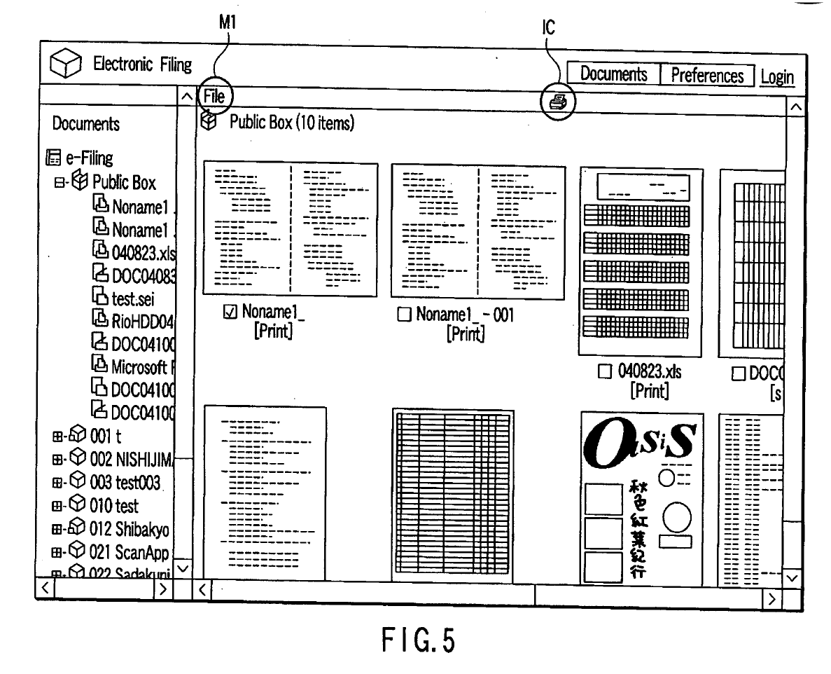

The user selects the predetermined document (i.e. the predetermined thumbnail) on the document selection screen by the input unit 24 of the terminal device 2 (ST112). Selection of the document (thumbnail) is completed by, for example, checking a check box of the thumbnail displayed on the document selection screen as shown in FIG. 5.

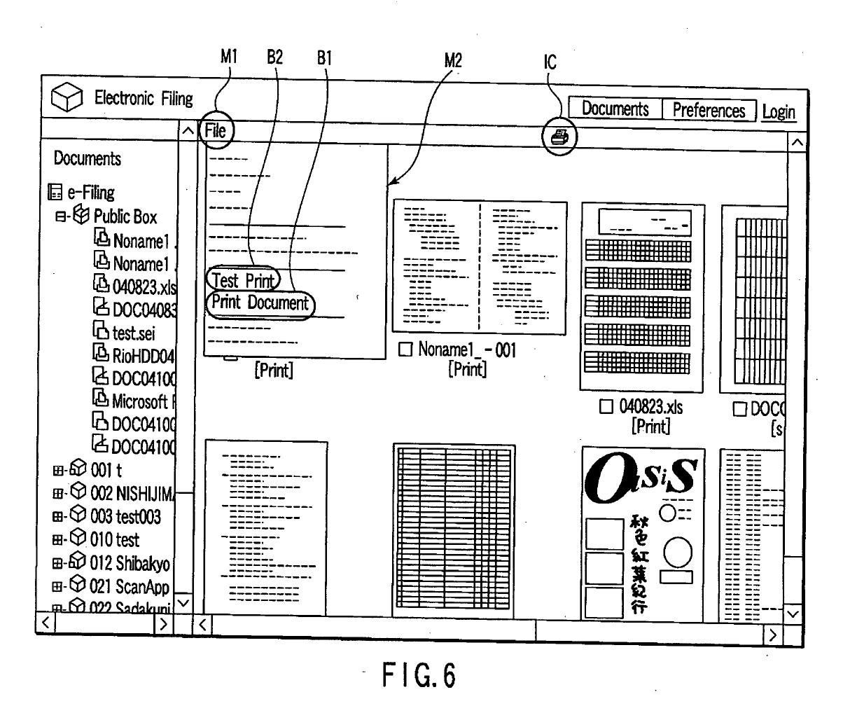

Furthermore, by selecting file menu M1 on a menu bar of the document selection screen by the input unit 24 of the terminal device 2, the user can display pull-down menu M2 as shown in FIG. 6. Print document button B1 to designate the general print and test print button B2 to designate the test print are displayed on the pull-down menu M2.

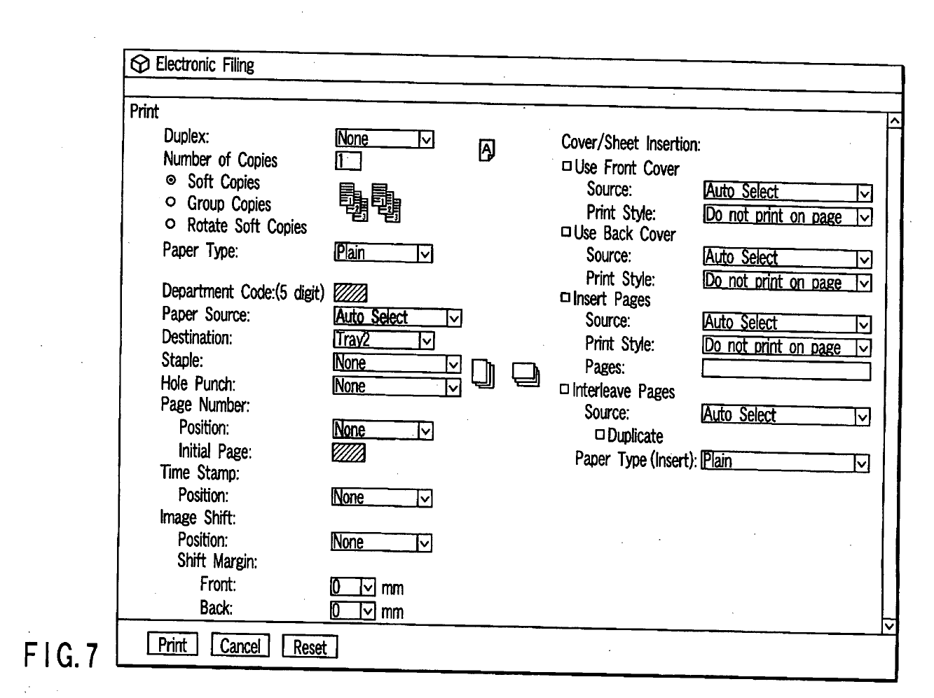

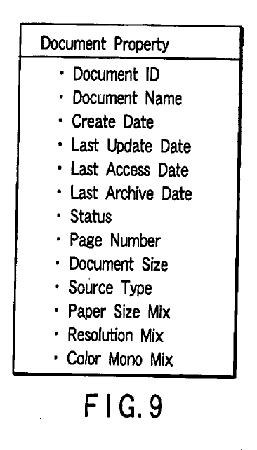

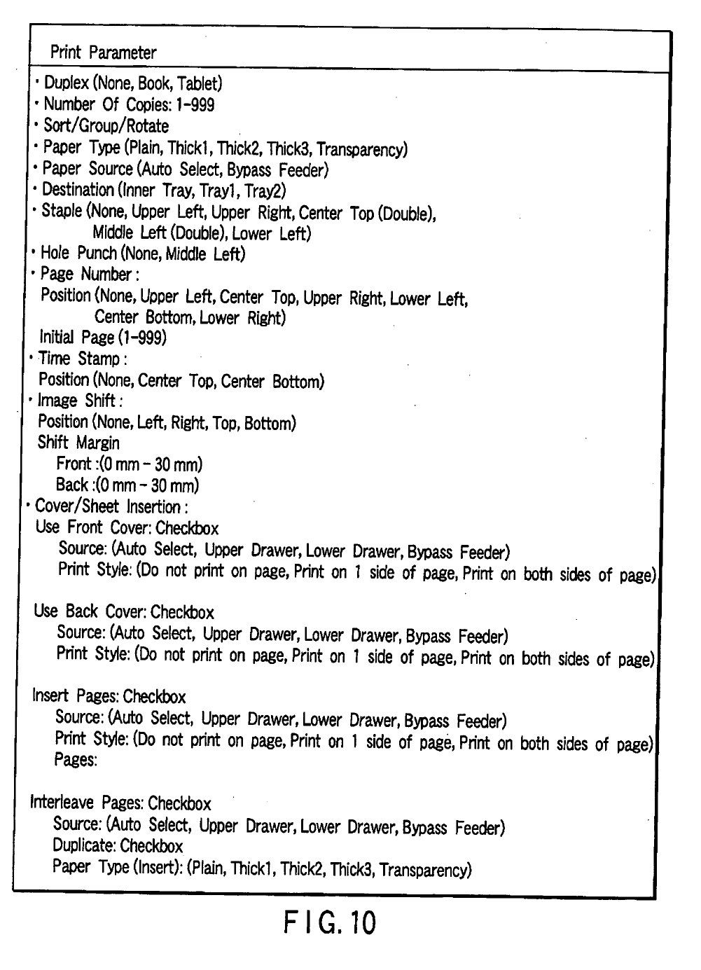

The user selects (i.e. pushes down) print document button B1 by the input unit 24 of the terminal device 2 to instruct the MFP 1 to execute the general print of the selected document (ST113). In response to this, the terminal device 2 (browser) instructs the MFP 1 to execute the general print of the selected document and requests a predetermined number of properties of the selected document and a predetermined number of print parameters (i.e. a predetermined number of print parameters prepared as the default status) of the selected document. The predetermined number of print parameters prepared as the default status are the values set under conditions determined when the document data is created (for example, when the document is scanned). The MFP 1 receives the general print instruction, further receives the request for properties and print parameters, and sends back properties and print parameters (all of print parameters) as shown in FIG. 9 and FIG. 10 to the terminal device 2. In response to this, the terminal device 2 (browser) acquires the properties and print parameters (all of print parameters) (ST121). Moreover, on the basis of the properties and print parameters (all of print parameters), the terminal device 2 (browser) displays a general print setting screen shown in FIG. 7 (ST122).

The user can set/change details of the print parameters on the general print setting screen. For example, if setting a department code is requested on the general print setting screen (ST114, YES), the user needs to set a department code in a department code field of the general print setting screen (ST115). Furthermore, if the user wishes to set/change the print parameters on the general print setting screen (ST116, YES), the user sets the predetermined print parameters in print parameter fields on the general print setting screen or changes the parameters in the print parameter fields (ST117). When setting the print parameters is completed, the user pushes down the print button on the general print setting screen (ST118). When Reset button on the general print setting screen is pushed down, the print parameters are reset as the defaults.

In response to the pushing of the print button on the general print setting screen, the terminal device 2 (browser) sends back the print parameters (all of print parameters) to the MPF 1. In other words, the terminal device 2 (browser) sets the print parameters (all of print parameters) to the MPF 1 (ST123). The communications unit 12 of the MPF 1 receives the print parameters (all of print parameters) sent back from the terminal device 2. On the basis of the print parameters (all of print parameters) sent back from the communications unit 12, the control unit 11 instructs the general print of the selected document. On the basis of the print parameters (all of print parameters) sent back from the communications unit 12, the printer unit 16 prints the selected document. The terminal device 2 (browser) displays execution of printing (ST124). If printing is successful (ST125, YES), the terminal device 2 (browser) displays notification of completion of the print instruction (ST126). If printing is failed (ST125, NO), the terminal device 2 (browser) displays an error message (ST127).

The list of the thumbnails of the respective documents is displayed on the document selection screen as shown in FIG. 4. In some cases, the contents of the document can be substantially understood from the thumbnail alone. For example, if an image is included in the thumbnail, the contents of the document can be substantially understood from the thumbnail.

However, if an image is not included in the thumbnail, i.e. if characters alone are included in the thumbnail, the contents of the document can hardly be substantially understood from the thumbnail. In addition, since there is the thumbnail of the document alone (i.e. the data of the document does not exist) on the terminal device 12 side, a print layout of the document cannot be displayed on the terminal device 12 side. Thus, by printing a copy of all of pages of the document, the contents of the document can be understood.

However, printing all of pages of the document having a number of pages only to understand its contents is waste of resources. Thus, printing pages of a part of the document for understanding of its contents is conceived, but the following problem arises.

To print pages of a part of the document, the print parameters need to be changed. For this reason, after acquiring all of the print parameters, it is necessary to change the print parameters (to select the print range) of the part and then send back all of the print parameters. In other words, to understand the contents, it is necessary to acquire all of the print parameters, change the print parameters of the part, and send back all of the print parameters. Thus, the contents cannot be easily understood for a short time.

To solve this problem, a test print as explained below is implemented. The test print will be explained with reference to a flowchart of FIG. 3 and the browser display screen of FIGS. 4 to 6 and 8.

The user selects a predetermined box (folder) in the large-capacity memory unit 17 of the MFP 1, on an initial screen of the browser of the terminal device 2 (ST211). In accordance with the box selection, the MFP 1 (communications unit 12) sends the thumbnail data of one or a plurality of documents inside the selected box. In response to this, the document selection screen as shown in FIG. 4 is displayed on the display unit 23 of the terminal device 2. A list of the thumbnails of the respective documents is displayed on the document selection screen.

The user selects the predetermined document (i.e. the predetermined thumbnail) on the document selection screen by the input unit 24 of the terminal device 2 (ST212). Selection of the document (thumbnail) is completed by, for example, checking a check box of the thumbnail displayed on the document selection screen as shown in FIG. 5.

Furthermore, by selecting file menu M1 on a menu bar of the document selection screen by the input unit 24 of the terminal device 2, the user can display pull-down menu M2 as shown in FIG. 6. Print document button B1 to designate the general print and test print button B2 to designate the test print are displayed on the pull-down menu M2.

The user selects (i.e. pushes down) print document button B2 by the input unit 24 of the terminal device 2 to instruct the MFP 1 to execute the test print of the selected document (ST213). In response to this, the terminal device 2 (browser) instructs the MFP 1 to execute the test print of the selected document and requests a predetermined number of properties of the selected document and one or a plurality of print parameters, of a predetermined number of print parameters (i.e. a predetermined number of print parameters prepared as the default status) of the selected document. One or a plurality of print parameters as requested may be one print parameter or two or more and less than the predetermined number of print parameters. For example, changeable print range select parameters may be adopted as one or a plurality of print parameters. Furthermore, the changeable print range select parameters may be parameters which select the predetermined page in the default status. Moreover, the changeable print range select parameters may be parameters which select the front page in the default status.

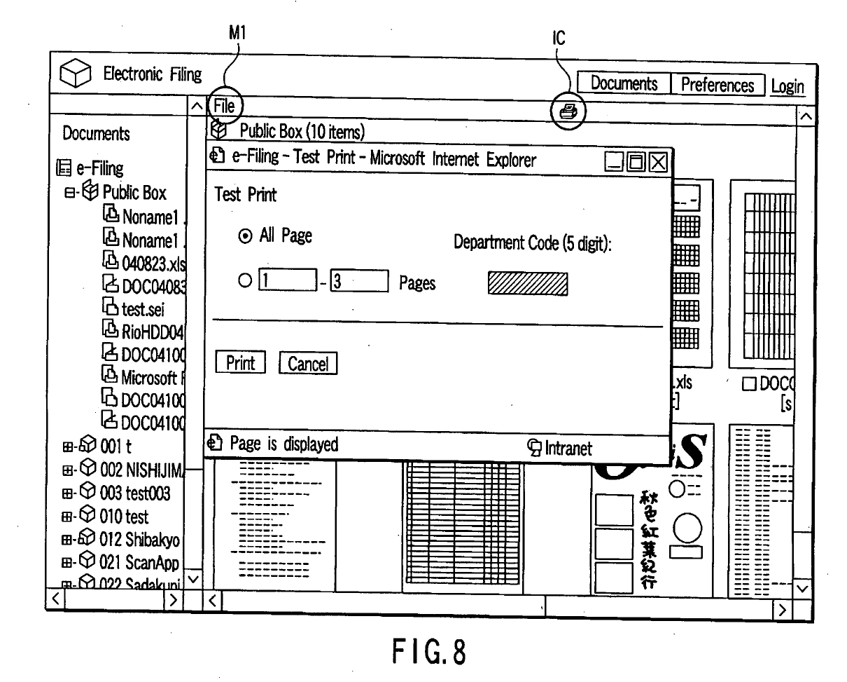

MFP 1 receives the test print instruction, further receives the request for the properties and one or a plurality of print parameters, and sends back the properties and the print parameters. In response to this, the terminal device 2 (browser) acquires the properties and print parameters (ST221). Moreover, on the basis of the properties and the print parameters, the terminal device 2 (browser) displays a test print setting screen (i.e. a popup window) shown in FIG. 8 (ST222). The test print setting screen is simpler than the general print setting screen. The user can understand the changeable print parameters (for example, the print range select parameters as explained above) directly from the test print setting screen.

The user can set/change one or a plurality of print parameters on the general print setting screen. Since the test print setting screen is based on the print parameters, the screen is simple such that the print parameters can easily be set/changed. For example, if setting a department code is requested on the test print setting screen (ST214, YES), the user needs to set a department code in a department code field of the test print setting screen (ST215). Furthermore, if the user wishes to change the print parameters on the test print setting screen (ST216, YES), the user changes parameters in print parameter fields on the test print setting screen (ST217). When setting the print parameters is completed or changing the print parameters is unnecessary, the user pushes down the print button on the test print setting screen (ST118).

On the test print setting screen shown in FIG. 8, “All Page” is selected (i.e. a radio button of “All Page” is checked) as the default. In other words, if the print button on the test print setting screen is pushed down in this status, a copy of all the pages of the selected document is printed under the conditions set when the selected document is created. The default status of the test print setting screen may be set in the following manner. For example, the front page alone may be selected in the default status of the test print setting screen. Otherwise, pages 1 to 2 may be selected and 2 in 1 print may be selected in the default status of the test print setting screen. The 2 in 1 print indicates setting of reducing an image over two pages and printing the image on one page. Otherwise, pages 1 to 4 may be selected and 4 in 1 print may be selected in the default status of the test print setting screen. The 4 in 1 print indicates setting of reducing an image over four pages and printing the image on one page. Otherwise, pages 1 to 2 may be selected and double-sided print may be selected in the default status of the test print setting screen. The double-sided print indicates setting of printing on a first side (top side) and a second side (back side) of a sheet. Otherwise, pages 1 to 4 may be selected, the 2 in 1 print may be selected and the double-sided print may be selected in the default status of the test print setting screen. The contents of the document can be efficiently understood by these defaults of the test print setting screen.

In response to the pushing of the print button on the test print setting screen, the terminal device 2 (browser) sends back one or a plurality of print parameters to the MPF 1. In other words, the terminal device 2 (browser) sets one or a plurality of print parameters to the MPF 1 (ST223). The communications unit 12 of the MPF 1 receives the print parameters sent back from the terminal device 2. The control unit 11 reflects the print parameters sent back from the communications unit 12 on the print parameters, and instructs the test print of the selected document on the basis of the reflected property data. On the basis of the reflected property data, the printer unit 16 prints the selected document. If the default status of the test print setting screen selects the front page alone and the print parameters are not changed, the front page alone of the selected document is printed. The terminal device 2 (browser) displays execution of printing (ST224). If printing is successful (ST225, YES), the terminal device 2 (browser) displays notification of completion of the print instruction (ST226). If printing is failed (ST225, NO), the terminal device 2 (browser) displays an error message (ST227).

In the above explanation, the test print button B2 in the pull-down menu M2 is selected (i.e. pushed down) and the MFP 1 is instructed to execute the test print of the selected document. To make the operation further simpler, however, the following measure can also be taken. As shown in FIG. 5, test print icon IC is displayed on a menu bar of the document select screen. The test print instruction of the selected document can be supplied to the MFP 1 by only selecting the test print icon IC. If the test print icon IC is used, the test print instruction can be supplied in less steps as compared with using the test print button B2 in the pull-down menu M2.

By the test print, the information which is sent and received between the MFP 1 and the terminal device 2 can be handled as required minimum information (one or a plurality of print parameters). In addition, the operation for setting the print range can be omitted by preliminarily selecting the print of the part (for example, the front page) of the document which the user wishes to understand. Even if the user wishes to select the print range (for example, the second page) different from the preliminarily selected print range (for example, the front page), the print range alone can be changed on the comprehensible and simple test print setting screen. Thus, the contents of the selected document can be simply understood for a short time.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A printer connectable with a terminal device via a network, comprising:
a sending unit which sends, in accordance with a test print instruction of a predetermined document from the terminal device, one or a plurality of print parameters, of a predetermined number of print parameters of the predetermined document, to the terminal device;
a receiving unit which receives the print parameter or the plurality of print parameters sent back from the terminal device;
a print instruction unit which instructs print of the predetermined document in accordance with the predetermined number of print parameters on which the print parameter or the plurality of print parameters sent back from the terminal device are reflected; and
a printing unit which prints the predetermined document in accordance with the predetermined number of print parameters on which the print parameter or the plurality of print parameters are reflected.

2. The printer according to claim 1, wherein
the sending unit sends one or a plurality of thumbnails, of one or a plurality of documents, to the terminal device, and
the receiving unit receives the test print instruction of the predetermined document corresponding to a predetermined one of the thumbnails, from the terminal device.

3. The printer according to claim 1, wherein the print parameter or the plurality of print parameters include a changeable print range select parameter.

4. The printer according to claim 3, wherein the changeable print range select parameter is a parameter which selects a predetermined page in a default status.

5. The printer according to claim 3, wherein the changeable print range select parameter is a parameter which selects a front page in a default status.

6. The printer according to claim 2, wherein
the receiving unit receives a general print instruction of a predetermined document corresponding to a predetermined thumbnail from the terminal device,
the sending unit sends the predetermined number of print parameters of the predetermined document to the terminal device, in accordance with the general print instruction of the predetermined document,
the receiving unit receives the predetermined number of print parameters sent back from the terminal device,
the print instruction unit instructs printing of the predetermined document, in accordance with the predetermined number of print parameters sent back from the terminal device, and
the printing unit prints the predetermined document, in accordance with the predetermined number of print parameters sent back from the terminal device.

7. A network print system in which a printer and a terminal device are connected via a network,
the printer comprising:
a first sending unit which sends, in accordance with a test print instruction of a predetermined document from the terminal device, one or a plurality of print parameters, of a predetermined number of print parameters of the predetermined document, to the terminal device;
a first receiving unit which receives the print parameter or the plurality of print parameters sent back from the terminal device;
a print instruction unit which instructs print of the predetermined document in accordance with the predetermined number of print parameters on which the print parameter or the plurality of print parameters sent back from the terminal device are reflected; and
a printing unit which prints the predetermined document in accordance with the predetermined number of print parameters on which the print parameter or the plurality of print parameters are reflected,
the terminal device comprising:
a second sending unit which sends the test print instruction of the predetermined document to the printer and which, in response to receiving of the print parameter or the plurality of print parameters from the printer, sends back the print parameter or the plurality of print parameters to the printer; and
a second receiving unit which receives the print parameter or the plurality of print parameters from the printer.

8. The network print system according to claim 7, wherein
the first sending unit sends one or a plurality of thumbnails, of one or a plurality of documents, to the terminal device,
the second receiving unit receives one or a plurality of thumbnails from the printer,
the second sending unit sends the test print instruction of the predetermined document corresponding to a predetermined one of the thumbnails to the printer, and
the first receiving unit receives the test print instruction of the predetermined document corresponding to the predetermined thumbnail from the terminal device.

9. The network print system according to claim 8, wherein the terminal device further comprises:
a display unit which displays one or a plurality of thumbnails received by the second receiving unit, and
a selecting unit which selects a predetermined one of the thumbnails displayed on the display unit and selects the test print of the predetermined document corresponding to the predetermined thumbnail.

10. The network print system according to claim 7, wherein the terminal device further comprises:
a display unit which displays a print parameter setting screen for test print in accordance with the print parameter or the plurality of print parameters received by the second receiving unit; and
a changing unit which changes the print parameter or the plurality of print parameters on the print parameter setting screen for test print,
and the second sending unit sends changes the print parameter or the plurality of print parameters on the print parameter setting screen.

11. The network print system according to claim 7, wherein the print parameter or the plurality of print parameters include a changeable print range select parameter.

12. The network print system according to claim 11, wherein the changeable print range select parameter is a parameter which selects a predetermined page in a default status.

13. The network print system according to claim 11, wherein the changeable print range select parameter is a parameter which selects a front page in a default status.

14. The network print system according to claim 8, wherein
the second sending unit sends a general print instruction of the predetermined document corresponding to the predetermined thumbnail to the printer,
the first receiving unit receives a general print instruction of the predetermined document from the terminal device,
the first sending unit sends the predetermined number of print parameters of the predetermined document to the terminal device, in accordance with the general print instruction of the predetermined document from the terminal device,
the second receiving unit receives the predetermined number of print parameters of the predetermined document from the printer,
the second sending unit sends back the predetermined number of print parameters of the predetermined document to the printer,
the first receiving unit receives the predetermined number of print parameters of the predetermined document sent back from the terminal device,
the print instruction unit instructs printing of the predetermined document in accordance with the predetermined number of print parameters sent back from the terminal device, and
the printing unit prints the predetermined document in accordance with the predetermined number of print parameters sent back from the terminal device.

15. The network print system according to claim 9, wherein the display unit displays a test print instruction key for selecting the test print.
